(19) United States
(12) Patent Application Publication
(10) Pub. No.: US 2006/0141885 A1
(43) Pub. Date: Jun. 29, 2006

(54) Apertured spunbond/spunblown composites

(76) Inventors: Susan Kathleen Cobbs, Atlanta, GA (US); Bryan David Haynes, Advance, NC (US)

Correspondence Address: Melanie I. Rauch;Pauley Petersen & Erickson, Suite 365, 2800 West Higgins Road, Hoffman Estates, IL, 60195, US

(21) Appl. No.: 11/022,554

(22) Filed: Dec. 23, 2004

(51) Int. Cl. B32B 5/26

(52) U.S. Cl. 442/382; 442/361; 442/381; 442/401; 156/60; 442/166

(57) ABSTRACT

A liquid-permeable laminate includes at least one layer of spunbond material and at least one layer of spunblown material. The laminate is apertured. The inclusion of the spunblown material results in hole uniformity in the apertured laminate. The invention also includes a method of forming the liquid-permeable laminate.

### BACKGROUND OF THE INVENTION

This invention is directed to liquid-permeable laminates that include spunbond and spunblown materials, and a method of forming these laminates.

Liquid-permeable materials are useful in a variety of product applications. For example, liquid-permeable materials may be used to form a bodyside liner of a personal care absorbent article. The liquid-permeability allows liquids to pass through the liner, away from the body, and into an absorbent core, which absorbs and retains the liquids.

Spunbond material can be processed or treated to be liquid-permeable. For instance, a spunbond material may be apertured to enhance liquid-permeability. However, the apertures may not be uniform or consistent due to the light, non-uniform fiber coverage of the spunbond material. Furthermore, the apertures may not be visually perceptible, in which case, the material may not be aesthetically pleasing. In certain products, it may be desirable for apertures to be visually distinct in order to supply the user or consumer with an immediate visual cue of liquid permeability.

There is thus a need or desire for improved sheet formation that results in a liquid-permeable material having consistent, identifiable apertures.

### SUMMARY OF THE INVENTION

In response to the discussed difficulties and problems encountered in the prior art, a new liquid-permeable laminate, as well as methods of forming such liquid-permeable laminates, has been discovered. The liquid-permeable laminates include at least one layer of spunbond material, and at least one layer of spunblown material. The laminates are apertured.

The spunblown material has a remarkable effect on the apertured composite. Compared to spunbond material alone, the spunbond/spunblown laminate has improved sheet formation and improved coverage, which results in improved aperture or hole quality and uniformity, as well as improved overall visual perception of the apertures formed within the sheet.

The liquid-permeable laminate may include a single layer of spunbond material and a single layer of spunblown material, or a layer of spunblown material positioned between two layers of spunbond material, or any additional layers of spunbond and/or spunblown material.

The fibers in the spunblown material suitably have an average diameter between about 4 and about 12 microns, or greater than about 10 microns, such as between about 10 and about 12 microns. The spunblown material may include low-melt fibers. The spunblown material and/or the spunbond material may include multicomponent fibers.

Only a small amount of spunblown material is necessary to impart the improved material attributes to the laminate. Suitably, the laminate may include between about 1% and about 15%, or between about 3% and about 8% by weight spunblown material. The laminate suitably has a basis weight between about 10 and about 30 grams per square meter.

The laminate may be formed by forming the layer or layers of spunbond material, forming the layer or layers of spunblown material, positioning the layers of spunbond and spunblown material in a laminar surface-to-surface relationship, and aperturing the resulting laminate, suitably setting the apertures in the process. The apertures may be set with heat. An aperture that has been heat set has a more defined shape and is more resilient compared to apertures that are not heat set. The apertures within the laminate suitably have an average diameter between about 1 and about 4, or between about 2 and about 3 millimeters.

With the foregoing in mind, it is a feature and advantage of the invention to provide a liquid-permeable material having uniform, perceptible apertures. It is another feature and advantage to provide a method of making an apertured liquid-permeable material having improved sheet formation.

### BRIEF DESCRIPTION OF THE DRAWINGS

These and other objects and features of this invention will be better understood from the following detailed description taken in conjunction with the drawings, wherein:

FIG. 1 is a photograph of one embodiment of a laminate of the invention.

FIG. 2 is a cross-sectional view taken along line 2-2 of FIG. 1 of one embodiment of a laminate of the invention.

FIGS. 3-5 illustrate cross-sectional views, similar to FIG. 2, of various embodiments of a laminate of the invention.

FIG. 6 is a schematic view illustrating one process by which the laminate of the invention can be prepared.

FIG. 7 is a schematic view of an aperturing assembly that may be incorporated into the process illustrated in FIG. 7.

FIG. 8 is a partial perspective view of an exemplary pattern roll that may be used in the aperturing assembly illustrated in FIG. 7.

### DEFINITIONS

Within the context of this specification, each term or phrase below will include the following meaning or meanings.

“Apertured” refers to a substrate that is porous, as opposed to non-porous, and specifically describes a substrate that has a number of holes or apertures connecting a first outer surface of the substrate with a second outer surface of the substrate. The apertures in an apertured substrate allow liquids as well as vapors and gases to freely pass through the substrate.

“Low-melt fibers” refer to fibers having a melting point below the melting temperature of the polymer used for the spunbond material. “Low-melt fibers” may also refer to fibers which, due to the smaller fiber size, melt before the spunbond component. Examples of these fibers include polyethylene or fine fiber polypropylene.

“Multicomponent fibers” refers to fibers or filaments that have been formed from at least two component polymers, or the same polymer with different properties or additives, extruded from separate extruders but spun together to form one fiber or filament. Multicomponent fibers are also sometimes referred to as conjugate fibers or bicomponent fibers, although more than two components may be used. The polymers are arranged in substantially constantly positioned distinct zones across the cross-section of the multicomponent fibers and extend continuously along the length of the multicomponent fibers. The configuration of such a multicomponent fiber may be, for example, a concentric or eccentric sheath/core arrangement wherein one polymer is surrounded by another, or may be a side by side arrangement, an “islands-in-the-sea” arrangement, or arranged as pie-wedge shapes or as stripes on a round, oval or rectangular cross-section fiber, or other configurations. Multicomponent fibers are taught in U.S. Pat. No. 5,108,820 to Kaneko et al. and U.S. Pat. No. 5,336,552 to Strack et al. Conjugate fibers are also taught in U.S. Pat. No. 5,382,400 to Pike et al. and may be used to produced crimp in the fibers by using the differential rates of expansion and contraction of the two (or more) polymers. For two component fibers, the polymers may be present in ratios of 75/25, 50/50, 25/75 or any other desired ratios. In addition, any given component of a multicomponent fiber may desirably comprise two or more polymers as a multiconstituent blend component.

“Nonwoven” and “nonwoven web” refer to materials and webs of material having a structure of individual fibers or filaments which are interlaid, but not in an identifiable manner as in a knitted fabric. The terms “fiber” and “filament” are used herein interchangeably. Nonwoven fabrics or webs have been formed from many processes such as, for example, meltblowing processes, spunblowing processes, spunbonding processes, air laying processes, and bonded carded web processes. The basis weight of nonwoven fabrics is usually expressed in ounces of material per square yard (osy) or grams per square meter (gsm) and the fiber diameters are usually expressed in microns. (Note that to convert from osy to gsm, multiply osy by 33.91.)

“Spunblown fibers” refers to macrofiber meltblown fibers, which are fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter. Thereafter, the spunblown fibers are carried by the high velocity gas stream and are deposited on a collecting surface to form a web of randomly dispersed spunblown fibers. The method is similar to forming conventional meltblown fibers, but differs in that the fibers have a larger diameter. More particularly, meltblown processes typically form microfibers (with average diameters less than about 10 microns), whereas spunblown processes typically form macrofibers (with average diameters from about 5 to about 50 microns). One example of a conventional meltblown method is disclosed, for example, in U.S. Pat. No. 3,849,241 to Butin et al., which is incorporated herein by reference in its entirety in a manner consistent with the present invention. Spunblown fibers are macrofibers, which may be continuous or discontinuous, and are generally tacky when deposited onto a collecting surface.

“Spunbond fibers” refers to small diameter fibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al.; U.S. Pat. No. 3,692,618 to Dorschner et al.; U.S. Pat. No. 3,802,817 to Matsuki et al.; U.S. Pat. Nos. 3,338,992 and 3,341,394 to Kinney; U.S. Pat. No. 3,502,763 to Hartman; and U.S. Pat. No. 3,542,615 to Dobo et al., each of which is incorporated herein by reference in its entirety in a manner consistent with the present invention. Spunbond fibers are generally not tacky when they are deposited onto a collecting surface. Spunbond fibers are generally continuous and have average diameters (from a sample of at least 10) larger than 7 microns (μm), more particularly, between about 10 and 25 microns (μm), or up to about 30 microns (μm) or more.

These terms may be defined with additional language in the remaining portions of the specification.

### DESCRIPTION OF PREFERRED EMBODIMENTS

In accordance with the invention, a liquid-permeable laminate includes the addition of spunblown material to spunbond material to improve the formation of apertures within the laminate.

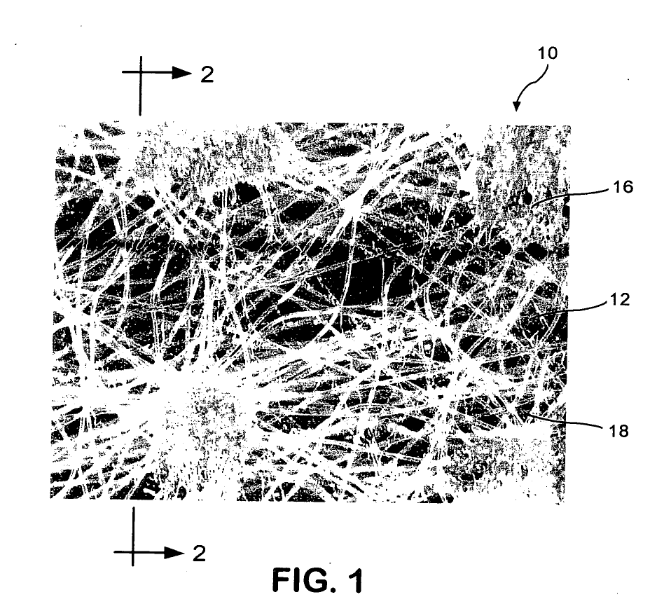

As shown in FIG. 1, a laminate 10 including a layer of spunblown fibers 16 and a layer of spunbond fibers 12, as viewed from atop the spunblown layer 16, has perceptible, uniform apertures 18.

The laminate 10 itself has improved sheet formation, compared to spunbond webs alone. This improved sheet formation is attributable, at least in part, to the inclusion of the spunblown layer 16. More particularly, the spunblown layer 16 provides additional coverage over a surface of the laminate 10. This improved sheet formation results in the improved hole quality and overall hole uniformity when the laminate is apertured. With respect to hole uniformity, the apertures are suitably within about 1 millimeter of a target aperture diameter, or within about 0.5 millimeter of a target aperture diameter.

The spunblown layer 16 can be formed using conventional meltblowing technology, but using the technology to form macrofibers instead of microfibers. More particularly, the method of formation involves extruding a molten polymeric material into fine streams and attenuating the streams by opposing flows of high velocity, heated gas (usually air) to break the streams into discontinuous fibers of small diameter. Subsequent collection of the fibers on a foraminous screen belt, drum, or the like yields a layer of the spunblown macrofibers. The spunblown layer is processed at a lower throughput than meltblown fibers, such as about 0.25 to about 0.5 grams per hole per minute (ghm). Operating at lower throughput allows formation of spunblown fibers at lower forming distances, such as about 3 to 4 inches. The spunblown layer possesses integrity due to entanglement of the individual fibers in the layer as well as some degree of thermal or self-bonding between the fibers, particularly when collection is effected only a short distance after extrusion. The resulting spunblown layer is highly uniform and can be deposited onto a spunbond web at high manufacturing speeds. The fiber size can be controlled depending on the application. In liner applications, for example, the process conditions may be set to produce larger fiber sizes in order to enhance coverage without sacrificing intake properties. In general, the macrofibers contained in the spunblown layer have an average fiber diameter between about 5 and about 50 microns, or between about 10 and about 20 microns. While the fibers in the spunblown layer are predominantly continuous, it is believed that the same function could be obtained through the use of discontinuous staple fibers.

The spunbond layer 12 can be formed using conventional spunbonding technology, as known to those skilled in the art. While many different spunbond methods are known, these methods generally involve continuously extruding a thermoplastic polymer (either from the melt or a solution) through a spinneret in order to form discrete filaments. Thereafter, the filaments are drawn (either mechanically or pneumatically) without breaking in order to molecularly orient the polymer filaments and achieve tenacity. Lastly, the continuous filaments are deposited in a substantially random manner onto a carrier belt or the like to form a web of substantially continuous and randomly arranged, molecularly oriented filaments. The spunbond fibers generally have an average fiber diameter between about 10 and about 40 microns, or between about 15 and about 30 microns, or between about 20 and about 25 microns. Due to the molecular orientation of the spunbond fibers, their tenacity is considerably higher than that of the spunblown fibers in the spunblown layer.

A wide variety of thermoplastic polymers may be used to prepare the spunblown layer 16 and the spunbond layer 12. The spunblown layer and the spunbond layer can be prepared from the same or different polymer types and two or more different polymers can be used in the preparation of either the spunblown layer or the spunbond layer or both. More particularly, the nonwoven fibers forming the spunblown layer and the spunbond layer may be monocomponent, bicomponent, or multi-component fibers. Thus, materials embodying the features of the invention can be fashioned with different physical properties by the appropriate selection of polymers or combinations thereof for the respective layers. Examples of suitable thermoplastic polymers include without limitation, polyolefins, polyamides, polyesters, polycarbonates, polystyrenes, thermoplastic elastomers, fluoropolymers, vinyl polymers, and blends and copolymers thereof.

Suitable polyolefins include, but are not limited to, polyethylene, polypropylene, polybutylene, and the like; suitable polyamides include, but are not limited to, nylon 6, nylon 6/6, nylon 10, nylon 12 and the like; and suitable polyesters include, but are not limited to, polyethylene terephthalate, polybutylene terephthalate and the like. Particularly suitable polymers for use in the present invention are polyolefins including polyethylene, for example, linear low density polyethylene, low density polyethylene, medium density polyethylene, high density polyethylene and blends thereof; polypropylene; polybutylene and copolymers as well as blends thereof. Additionally, the suitable fiber forming polymers may have thermoplastic elastomers blended therein.

The spunblown material 16 may include low-melt fibers, such as polyethylene, or fibers finer than the fibers in the spunbond layer, and combinations thereof. Although not wishing to be bound by theory, it is believed that the low-melt characteristic provided by the spunblown fibers, and/or having a low-melt fiber as one component in multicomponent fibers, allows the hole structure to heat set during the aperture process, which is described in greater detail below.

In general, the softening point of the polymer in the spunblown layer 16, or a portion thereof, should be at least about 5 degrees Celsius less than the softening point of the spunbond layer 12 polymer and not more than about 40 degrees Celsius, or 35 degrees Celsius, lower. If the spunblown polymer softens at a temperature appreciably below the spunbond polymer, it is difficult to achieve appropriate bonding without an accompanying adverse film forming effect on the surface of the spunblown layer. Differential Thermal Analysis (DTA) can be used to establish the softening point. The softening point is the temperature at which the DTA graph first exhibits a change of slope. While different polymer types ordinarily have different softening points, it will be appreciated that polymers of the same type, e.g., polypropylene, can have different softening points depending, for example, on molecular weight, etc.

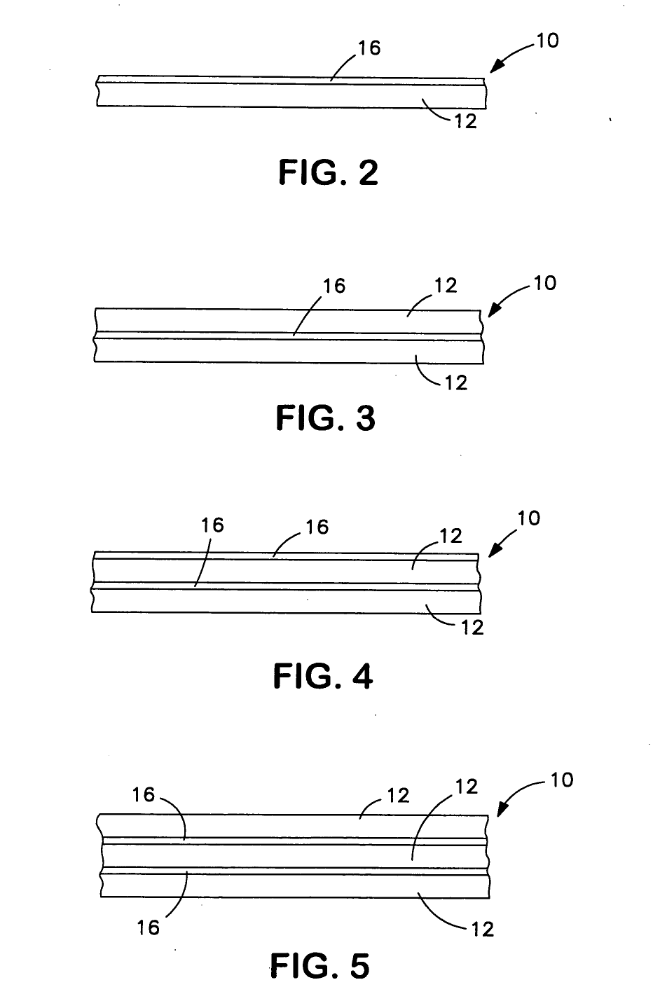

The laminate 10 may be composed substantially of the spunbond layer 12, and may include just a thin spunblown layer 16. For example, the laminate 10 may have an overall basis weight between about 10 and about 30, or between about 12 and about 25, or between about 16 and about 21 grams per square meter (gsm). The laminate 10 may include between about 2% and about 12%, or between about 4% and about 6% by weight spunblown material. The spunbond fibers and spunblown fibers may be present in single layers or in multiple layers. For example, the laminate 10 may include a single layer of spunbond material 12 and a single layer of spunblown material 16, as shown in FIG. 2. Alternatively, the layer of spunblown material 16 may be positioned between two layers of spunbond material 12, as shown in FIG. 3. Other alternative embodiments include two layers of spunblown material 16 positioned in an alternating fashion with two layers of spunbond material 12, as shown in FIG. 4, or two layers of spunblown material 16 positioned in an alternating fashion between three layers of spunbond material 12, as shown in FIG. 5. Any suitable combination of spunbond layers 12 and spunblown layers 16 may be included in the laminate 10.

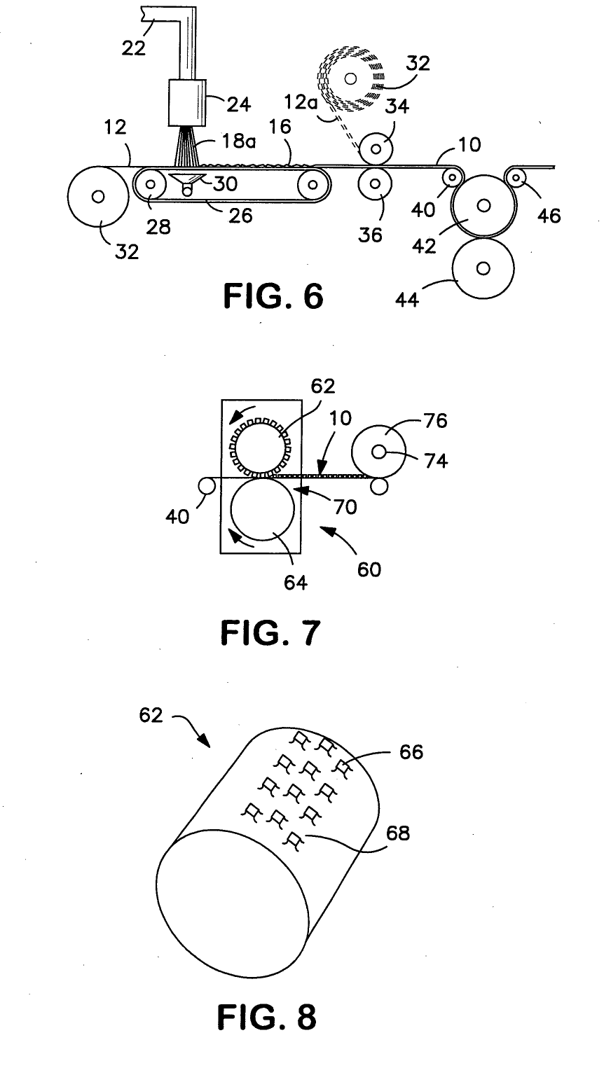

Referring to FIG. 6, there is illustrated one method of forming the liquid-permeable laminate 10. Preparation of the spunblown layer 16 can be carried out by introducing a polymer into an extruder (not shown) to melt and pump the polymer, and conducting the molten polymer through a polymer pipe or conduit 22 and extruding the polymer through a meltblowing die 24 containing a single row of orifices. High pressure air is used to attenuate the polymer streams into continuous filaments that are randomly deposited onto a spunbond layer 12. The spunbond layer 12 may be a preformed, integrated spunbond web unwound from a roll 32. Alternatively, the spunbond web 12 may also be formed inline using conventional spunbond forming methods. For example, spunbond web 12 may be formed inline and the spunblown layer 16 may be conveniently formed directly on top of the spunbond web 12. Optionally, the spunbond layer 12 and spunblown layer 16 may be conveyed along a moving foraminous carrier belt 26 driven over roll 28 with appropriate suction means 30 situated beneath the carrier belt to assist in web formation. The spunblown layer 16 and the spunbond layer 12 may pass through a nip between rolls 34, 36 to form the unbonded two-ply laminate 10.

As another alternative, shown in dotted lines in FIG. 6, preparation of a laminate 10 such as depicted in FIG. 3 can be accomplished by combining a second spunbond layer 12a with the spunbond layer 12 and spunblown layer 16 at the nip formed by the rolls 34 and 36, and thereafter passing the three-ply composite through the roll 42, 44 bonding nip. Similarly, it will be understood that other constructions embodying the features of the invention can be formed through similar modifications to the method.

Ply attachment between the spunbond layer 12 and the spunblown layer 16 can be effected through heat and/or pressure, either prior to or concurrent with the aperturing of the laminate 10. For example, the spunbond layer 12 and spunblown layer 16 may be bonded together prior to aperturing by passing the unbonded laminate 10 over idler roll 40 and into contact with heated smooth surfaced roll 42 and subsequently through a pressure nip formed between the heated roll 42 and heated roll 44. The bonded laminate is then removed from the roll 42 over idler roll 46. Alternatively, rolls 34, 36 may be used for bonding/calendering the layers 12, 16. Other methods of bonding the layers together may also be used, such as the use of an applied adhesive or mechanical interlocking of the fibers, such as by needling techniques or the like.

Alternatively, the spunbond and spunblown layers 12, 16 can be bonded together through the aperturing process. Any conventional aperturing technique can be used. Examples of suitable aperturing methods are described in U.S. Pat. No. 4,820,294 to Morris, and in U.S. Pat. No. 4,469,734 to Minto, each of which is incorporated herein by reference in its entirety in a manner consistent with the present invention. The laminate 10 itself, because of the inclusion of the spunblown layer 16, imparts the final perceived benefits to the apertured laminate regardless of the aperture technology.

One example of a process and apparatus for suitably aperturing the laminate 10 is illustrated in FIG. 7, wherein the unapertured, continuous laminate, with the layers either bonded together or existing as unbonded plies arranged in face-to-face or laminar relation, is subjected to the aperturing assembly generally shown as element 60. The aperturing assembly 60 can replace (or follow) heated rolls 42 and 44 in FIG. 5. The aperturing assembly 60 includes a pattern roll 62 and an anvil roll 64, both of which are driven and/or braked with respect to one another so as to create a speed differential between the two rolls 62 and 64. Suitable means for driving the pattern roll 62 and the anvil roll 64 include, for example, electric motors (not shown).

The pattern roll 62 is typically made from a durable material such as steel. Pattern roll 62 has a pattern of raised areas or protuberances 66 (shown in FIG. 8) separated by a pattern of depressed areas 68. Protuberances 66 are designed to contact the surface of anvil roll 64. The size, shape, pattern, and number of protuberances 66 on the pattern roll 62 may be varied to meet the particular characteristics desired in the apertured laminate. For example, the protuberances 66 on the pattern roll 62 in FIG. 8 may be used to form square, circular, oval, or diamond pattern apertures. The bond area or apertured area of the resulting laminate may be between about 8% and about 40%, or between about 10% and about 20%, or between about 12% and about 15% of the entire laminate surface area. Additionally, the apertures may have an average diameter between about 1 and about 4 millimeters, or between about 2 and about 3 millimeters.

Anvil roll 64 is characterized in that its surface is much smoother than the pattern roll 62 and is suitably flat. Anvil roll 64, however, may exhibit a slight pattern and still be considered flat. For example, if the anvil roll is made from or has a softer surface than the pattern roll 62, such as a resin impregnated cotton or a rubber surface, it may develop irregularities yet will still be considered flat. Anvil roll 64 provides the base for the pattern roll 62 and laminate to shear against. Typically, the anvil roll 64 will be made from steel or materials such as hardened rubber, resin-treated cotton, or polyurethane.

Both the pattern roll 62 and the anvil roll 64 may be provided with devices (not shown) for heating their surfaces to desired temperatures. Heating and/or cooling can affect the features of the apertured laminate produced. Common heating devices include hot oil and electrical resistance heating. An aperture that has been heat set has a more defined shape and may be more resilient than an aperture that has not been heat set. Alternatively, or in addition, the laminate material itself may have heat applied to it at or just prior to entry into the nip, by methods known in the art such as heated air, infrared heaters, and the like. However, the application of heat is not necessary for setting apertures.

The anvil roll 64 and pattern roll 62 are counter-rotated at differential speeds. The speeds are generally measured at the surfaces of the rolls and may be expressed as a ratio of pattern roll speed to anvil roll speed. In use, the pattern roll 62 will usually run at a faster speed than the anvil roll 64. However, in certain instances, it might be desirable to run the rolls at the same speed or run the anvil roll 64 faster than the pattern roll 62.

The position of the anvil roll 64 and pattern roll 62 with respect to each other may be varied to create a nip area 70 between the rolls. The nip pressure can be varied depending upon the properties of the laminate itself and the type of aperturing desired and is usually controlled by hydraulic cylinders (not shown) connected to the rolls.

The differential speed and pressure between the pattern roll 62 and the anvil roll 64 cause a shear between the protuberances 66 on the pattern roll 62 and the surface on the anvil roll 64. This shearing action acts to score the laminate and create apertures therethrough.

As the apertured laminate 10 leaves the aperturing assembly 70, it may then be collected on a winder 74 to form a roll of apertured laminate 76.

In one embodiment, for example, the laminate has an overall basis weight of 17 gsm, and includes one layer of polypropylene spunbond fibers having an average diameter of 20 microns, and one layer of polypropylene spunblown fibers having an average diameter of 10 microns. The spunblown layer accounts for 4.6% by weight of the laminate. The uniform apertures in the laminate have an average diameter of 3 millimeters.

The liquid-permeable laminate of the invention can be incorporated into a variety of products, including, for example, disposable absorbent articles, particularly as a body-contacting layer or a liner material in such articles. Absorbent articles include personal care absorbent articles such as diapers, diaper pants, training pants, swimwear, absorbent underpants, adult incontinence products, feminine hygiene products, and the like, as well as medical absorbent articles such as medical absorbent garments, bandages, masks, wound dressings, underpads, wipes, and the like. Disposable absorbent articles are typically disposed of after 1-5 uses.

It will be appreciated that details of the foregoing embodiments, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

What is claimed is:

1. A liquid-permeable laminate comprising:
a layer of spunbond material; and
a layer of spunblown material bonded to the spunbond material, wherein the laminate is apertured.

2. The laminate of claim 1, wherein the layer of spunblown material comprises fibers having an average diameter between about 4 and about 12 microns.

3. The laminate of claim 1, wherein the layer of spunblown material comprises fibers having an average diameter greater than about 10 microns.

4. The laminate of claim 1, wherein the layer of spunblown material comprises low-melt fibers.

5. The laminate of claim 1, wherein the layer of spunblown material comprises multicomponent fibers.

6. The laminate of claim 1, wherein the layer of spunbond material comprises multicomponent fibers.

7. The laminate of claim 1, wherein the laminate comprises between about 1% and about 15% by weight spunblown material.

8. The laminate of claim 1, wherein the laminate comprises between about 3% and about 8% by weight spunblown material.

9. The laminate of claim 1, having a basis weight between about 10 and about 30 grams per square meter.

10. The laminate of claim 1, wherein the apertures have an average diameter between about 1 and about 4 millimeters.

11. The laminate of claim 1, wherein the apertures have an average diameter between about 2 and about 3 millimeters.

12. A liquid-permeable laminate comprising:
two layers of spunbond material; and
a layer of spunblown material positioned between the two layers of spunbond material, wherein the laminate is apertured.

13. The laminate of claim 11, further comprising at least one additional layer of spunblown material.

14. The laminate of claim 11, further comprising at least one additional layer of spunbond material.

15. The laminate of claim 11, wherein the layer of spunblown material comprises fibers having an average diameter between about 4 and about 12 microns.

16. The laminate of claim 11, wherein the layer of spunblown material comprises fibers having an average diameter greater than about 10 microns.

17. The laminate of claim 11, wherein the layer of spunblown material comprises low-melt fibers.

18. The laminate of claim 11, wherein the layer of spunblown material comprises multicomponent fibers.

19. The laminate of claim 11, wherein at least one of the layers of spunbond material comprises multicomponent fibers.

20. The laminate of claim 11, wherein the laminate comprises between about 1% and about 15% by weight spunblown material.

21. The laminate of claim 11, wherein the laminate comprises between about 3% and about 8% by weight spunblown material.

22. The laminate of claim 11, having a basis weight between about 10 and about 30 grams per square meter.

23. The laminate of claim 11, wherein the apertures have an average diameter between about 1 and about 4 millimeters.

24. The laminate of claim 11, wherein the apertures have an average diameter between about 2 and about 3 millimeters.

25. A method of forming a liquid-permeable laminate, comprising:
forming a layer of spunbond material;
forming a layer of spunblown material;
positioning the layers of spunbond material and spunblown material in a laminar surface-to-surface relationship; and
aperturing the layers of spunbond material and spunblown material.

26. The method of claim 25, further comprising forming an additional layer of spunbond material, and forming the layer of spunblown material between the two layers of spunbond material.

27. The method of claim 25, comprising heat setting the apertures.

28. The method of claim 25, comprising bonding the layers of spunbond material and spunblown material to one another prior to aperturing the layers of spunbond material and spunblown material.

29. The method of claim 25, comprising bonding the layers of spunbond material and spunblown material to one another while aperturing the layers of spunbond material and spunblown material.
